(19) United States
(12) Patent Application Publication
(10) Pub. No.: US 2012/0096079 A1
(43) Pub. Date: Apr. 19, 2012

(54) GENERATING A WEB PAGE WITH IDENTIFIED SOURCES OF DATA

(75) Inventors: Robert E. BRAZILE, Arlington, MA (US); Charles P. MOREHEAD, Cambridge, MA (US); William M. TARBELL, Newtown Square, PA (US)

(73) Assignee: ORACLE INTERNATIONAL CORPORATION, Redwood Shores, CA (US)

(21) Appl. No.: 13/275,611

(22) Filed: Oct. 18, 2011

Related U.S. Application Data
(60) Provisional application No. 61/394,199, filed on Oct. 18, 2010.

(51) Int. Cl. G06F 15/16

(52) U.S. Cl. 709/203

(57) ABSTRACT

A system/server responds to a request for a web page from a client computer. The system determines a plurality of data elements required to generate the web page, and requests and receives the plurality of data elements. Each data element may be requested and received from a respective source. For each respective source, the system generates a source association tag that identifies the source and the corresponding data element. The system then generates the web page comprising the plurality of data elements and corresponding source association tags, and transmits the web page to the client.

### CROSS REFERENCE TO RELATED APPLICATIONS

This application claims priority of U.S. Provisional Application Ser. No. 61/394,199, filed on Oct. 18, 2010, the contents of which is hereby incorporated by reference.

### FIELD

Embodiments are generally directed to servers and browsers and the information exchanged between them. In particular, embodiments are directed to browsers capable of reading and displaying certain embedded diagnostic characteristics in a page served by servers to the browsers, and to techniques for generating, reading, editing, and modifying such pages.

### BACKGROUND INFORMATION

The Internet and related networks and data referred to as the World Wide Web (or Web) comprise millions of nodes located around the world at which different types of machines are disposed in a recognizable address space. The machines connected to the Web are adapted to generate information and to organize the information in a format that can be transmitted to other machines on the Web and be recognized and processed by the other machines.

One type of machine is referred to as a “server” because it includes program instructions or software that enable a server to generate and “serve” formatted information (“pages”) to other machines. The other machines may be other servers or may be “client” machines that request the information served by the servers in what is commonly referred to as Web pages. The Web pages include characters and content according to recognized protocols, e.g. various markup languages, which can be read and acted upon by the client machines. The client machines include instructions or software to enable the clients to receive, parse, and typically display an output corresponding to the information contained in the formatted Web pages received from the servers.

Many millions of Web pages are generated and circulated about the Web each day or each hour. Most Web pages are informational in nature, and many Web pages deliver information to a client about a certain topic to which the Web pages are directed. If the Web page is pre-formatted and packaged for serving to clients by a server, and undergoes no modifications or customization at the time of its request, it is most likely a “static” Web page type. Static Web pages would generally appear the same, and deliver substantially the same information, no matter which client requests the page and regardless of the time or circumstances or the request for the static Web page.

However, another type of Web page includes information that is customized for the client or request made on the server, and will generally include information that is collected and formatted at the time of the request for the page. This type of Web page is sometimes referred to as an “active” or “dynamic” content Web page because its content is created dynamically based on the circumstances and nature of the request for the page. Typical examples of dynamic Web pages are those that deliver to a client information about current weather, news, sports scores, the time of day, stock market data, or other information that would be uninformative or outdated if it were pre-packaged into a pre-formatted static Web page. That is, dynamic Web pages are useful for delivering content that is time sensitive, geographically-dependent, or that is dependent on the identity of the requesting client or the nature of the client's request.

One example of dynamic Web pages is a page created and served in the context of online shopping. When a user of a client machine is browsing the Internet in order to make an online purchase, the client interacts with a server in order to receive organized and current information from the server about the products of interest. Electronic commerce vendors or retailers with online shopping stores attempt to design and arrange their servers to provide information from databases or “stores” in a way that encourages the completion of online sales to their customers. The nature and presentation of the information about the product offerings, and the prices of the products, have a substantial impact on the ability of the customers to find the items they are interested in and to finalize the sale of these items. Therefore, the arrangement and content of Web pages in electronic commerce (“e-commerce”), especially in the context of online shopping sites, is of great interest to the online retail sector.

Modern Web pages for online retail and similar e-commerce transactions, as well as other applications, have become very complex and incorporate a large amount of textual and media information into a single page served by the server to the client. In fact, several or many different authors, entities, databases, and server devices, are commonly involved in contributing information for inclusion into a Web page, especially in Web pages provided in online shopping or e-commerce transactions.

### SUMMARY

One embodiment is a system/server for responding to a request for a web page from a client computer. The system determines a plurality of data elements required to generate the web page, and requests and receives the plurality of data elements. Each data element may be requested and received from a respective source. For each respective source, the system generates a source association tag that identifies the source and the corresponding data element. The system then generates the web page comprising the plurality of data elements and corresponding source association tags, and transmits the web page to the client.

### BRIEF DESCRIPTION OF THE DRAWINGS

FIG. 1 illustrates a schematic client-server environment according to the prior art.

FIG. 2 illustrates a simplified architecture for generation of a web page in accordance with one embodiment.

FIG. 3 illustrates a plurality of requests and responses in accordance with one embodiment.

FIG. 4 illustrates a web page with a plurality of web page elements and a display element showing information from a source association tag in accordance with one embodiment.

### DETAILED DESCRIPTION

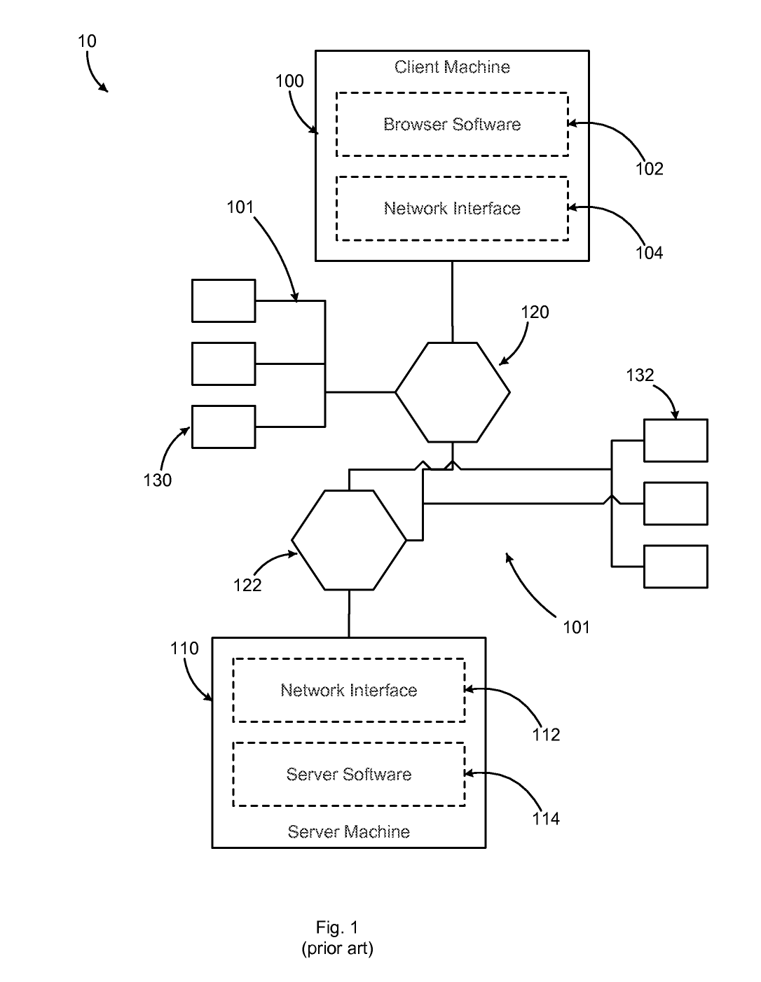

FIG. 1 illustrates a simple representation of a network 10 such as those used for communicating between various machines coupled to the nodes of the network. The network includes communication pathways 101 that carry data, for example in a format compatible with an electronic communication protocol (e.g., TCP/IP, HTTP, etc.) between various machines on the network. The network includes at least one machine that is equipped with software and functionality to qualify it as a “server” machine 110. The network is also coupled by way of one or more hubs 120, 122 to other machines 130, 132, which in turn may be coupled to many other sub-nets and local networks and machines and peripherals. The network is also coupled to at least one machine that is equipped with software and functionality to qualify it as a “client” machine 100.

Some or all of the machines on network 10 include hardware and/or software providing network communication functionality. A network interface module 104 allows client machine 100 to send and receive information to and from the network. A network interface module 112 allows server machine 110 to send and receive information to and from the network. In some cases the machines have a hardware network interface card and related instructions to accomplish the network communication task. It should be understood that the miscellaneous communications over network 10 can include communications over hard wired channels, wireless channels, optical, telephone, or other communication paths without loss of generality.

Client machine 100 is specifically loaded with software for making requests for information from a server and for processing information received from the network, and can include browser software 102 that allows client machine 100 to browse, or view in a determined form and to display the results of information served to the client machine 100. The server machine 110 is loaded with server software 114 for processing requests from a client and for formatting and serving information to a client.

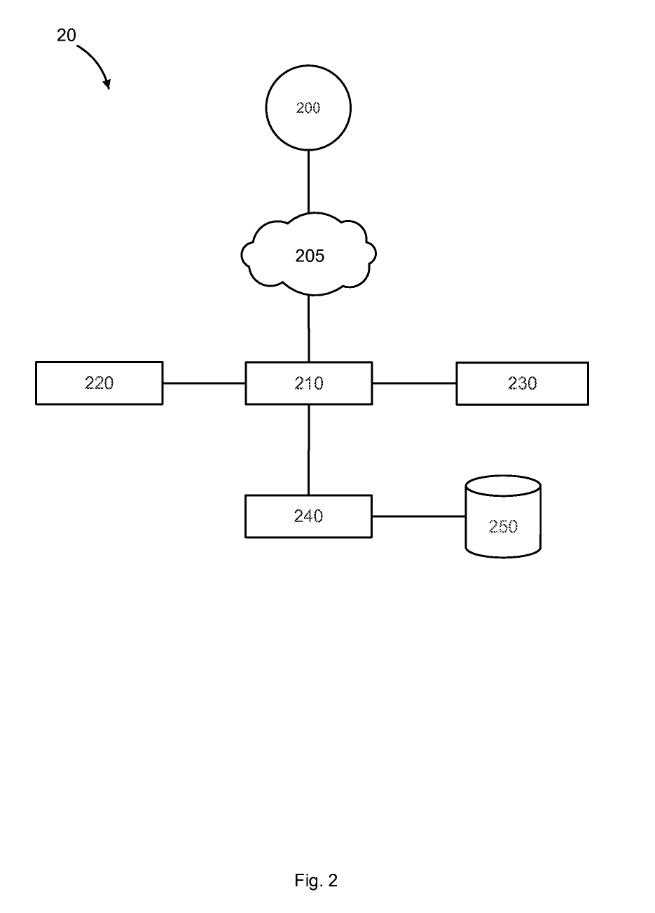

FIG. 2 illustrates a schematic and simple layout of a network 20 having a client 200 that is coupled to one or more servers through a network 205, which may rely at least in part on Internet communications and which may include hypertext transfer protocol (HTTP) formatted communications in accordance with one embodiment. As disclosed above, the client 200 may include a network communication module and may include a browser program that suitably makes requests for information and receives responses from a server that can be reviewed on the client's browser. The browser in one embodiment can be any standard known browser that allows a user to access web pages from a server in a known manner.

A server, e.g., a “web server” 210, receives requests for information or pages from client 200 and formats and returns the information responsive to the client's request. This response by the server is contingent upon the requested information being available to server 210 and is contingent upon the server determining that the request from client 200 was in fact valid under the existing operational circumstances. For example, a client 200 may be required to provide authentication information in order to receive certain information from server 210. Also, the information requested by client 200 should be available to server 210, directly or indirectly, so that server 210 can include this information in the web pages. In some embodiments the returned pages are in or include hypertext markup language (HTML) or another form of markup language that can be parsed by the client browser and presented to a user thereof.

In some embodiments, other server machines 220, 230, 240 may be coupled to web server 210. The other server machines may include software and instructions executing thereon so that they contribute at least some information to be provided by web server 210 to client 200 as a result of the client's request. For example, in the context of online shopping or e-commerce transactions, client 200 may provide a request for information by clicking on or selecting an entry that the client sees in his or her browser application on client 200 using an input device such as a computer mouse or keyboard key. The clicking on the selected entry or item causes a request to be transmitted, in a known format, from client 200 to a server 210 identified with the item that was selected.

Once the client's request is received by web server 210, the server determines the nature of the request and other information needed to process the request. For example, the location of client 200, the identity of client 200 or a user thereof, or other environmental parameters may be taken into account when processing the request. In one embodiment, further contributions from other machines or peripherals available to web server 210 are used in formulating a response to the client request.

In one embodiment, another server 220 may be responsible for authenticating the client 200 so that the system can determine what information can or should be provided to client 200. This may include, for example, user ID or password, account number, or other log-in information for confirmation against a known list or database by server 220. Note that the use of the term “server” in this example is intended generally to mean a machine or computer or device that has functionality to service a client request, even if indirectly or in part. That is, the servers 220, 230 and 240 may not necessarily have direct communication with requesting client 200, but are in some way contributing to the response thereto.

Further, another server 230 may be responsive to requests made thereon (e.g., by web server 210) to retrieve images or graphics or sounds or other media files for inclusion in a response page delivered to client 200 by web server 210.

In addition, another server 240 may be tasked with providing pricing data corresponding to objects of interest to the customer using client machine 200. In some embodiments, the pricing data, and any data processed by any of the servers, may be retrieved from a database 250 coupled to the respective server. Here, database 250 is coupled to server 240 and contains pricing information that is kept current by a pricing or marketing department and associates a context-dependent price with a given request. For example, a special user having an employee discount privilege, or a special user having a corporate or courtesy discount coupon, may provide the information about this special discount in the request, which is then authenticated by server 220 and server 240 retrieves the pricing information for the appropriate discount.

Other servers may be tasked with performing other functions. For example, along the lines described above, a server may be responsible for generating bundle offers or other advertising content or affinity-based offers or customer segmentation or customer preference based offers to client 200. These offers or promotional information are provided to web server 210 for inclusion in the final formatted page returned to client 200. Yet other examples of server-based functions include load balancing, page server functions, inventory control, security, and others.

All of the server activity may take place invisibly to an ordinary customer on client computer 200. The customer would see in his or her browser the results of a formatted web page returned by web server 210 to client 200, which then uses its browser and other client software to display and present the results to a user. The contributions to the formatted web page are thus the result of tasks performed by a plurality of server machines and/or server-based programs executing in one or more server machines. In some embodiments, one physical computing machine may include a plurality of software modules to perform the above server tasks. In other embodiments, a plurality of interconnected machines perform the various server functions as needed. Therefore, it is not intended to limit the present description that the plurality of servers are illustrated in the form shown in the embodiment above.

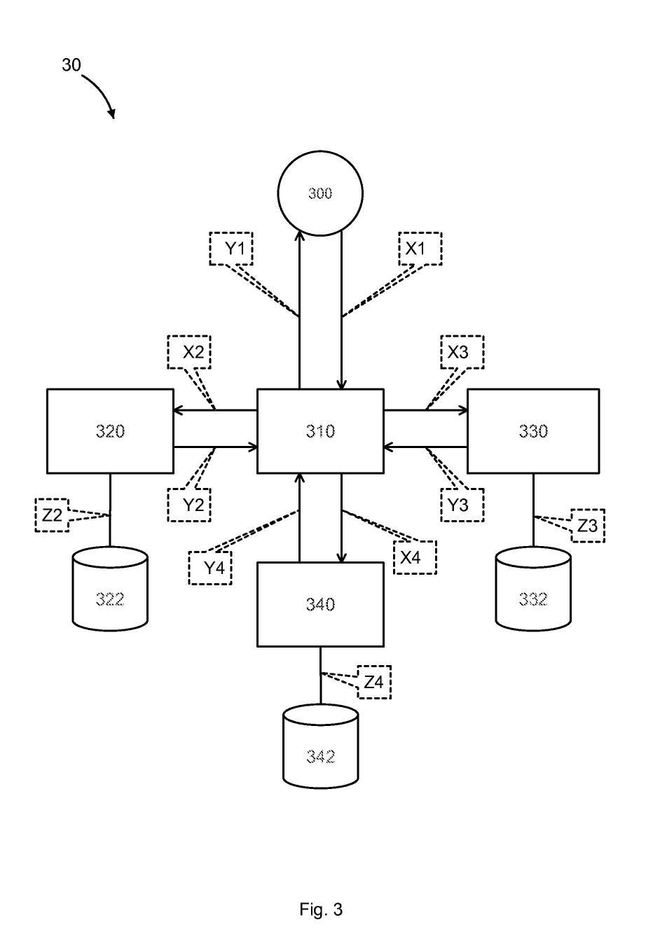

FIG. 3 illustrates a system 30 in a simple and schematic manner in which an example request from a client 300 is processed by a plurality of servers and/or contributors to a response to the request in accordance to one embodiment.

Client 300 sends a request X1 to a web server 310, the request and response model for which is generally similar to that described earlier, and which may rely on Internet communication channels using known protocols. Web server 310 receives first request X1 and determines using software modules, or using hardware modules and processing circuitry on server 310 executing computer-readable instructions, that a response is to be provided to client 300.

In order to formulate the appropriate response to client 300, server 310 passes on a second request X2 to a second server 320. The request X2 is formulated by server 310 in a known format, or is provided by passing on the same request X1 originally sent by client 300, or a portion thereof. Second server 320 processes the second request X2 and returns to first server 310 a response Y2. Response Y2 may be in a known format for server 310 to incorporate into a web page, and may include data or information responsive to second request X2, which, by extension, is responsive to first request X1. The data returned in response Y2 may incorporate or contain data Z2 received from a database 322 or storage device holding data corresponding to the request made on second server 320. In one embodiment, the request and response on second server 320 may include authentication information relating to client 300.

Similarly, a third server 330 receives a third request X3 from the first (web) server 310, and responds with corresponding responsive response Y3, which may include data Z3 from database or storage medium 332. In one embodiment, response Y3 includes information relating to an offer to be given to a user of client 300, said offer corresponding to the identity of or other information about client 300 or its user.

Yet another server 340 receives a fourth request X4 from first (web) server 310. Server 340 may retrieve responsive data Z4 from a database 342 and return a response Y4 to the first server 310. In one embodiment, the data Z4 includes product data about one or more products offered in an online shopping transaction, and may include descriptive text, images, dimensions, specifications, pricing data, or other descriptive information about a product or group of products of interest relevant to the original request X1 from client 300.

The following embodiments are directed to the nature of the web pages returned by the web server, e.g. server 310.

As far as a client 300 is concerned, the client 300 wishes to retrieve information responsive to the client's request X1. The information is typically returned in the form of a web page Y1 having entries and data, images, and information corresponding to the original request X1 and deriving from all of the above sources of information to satisfy the request. Conventional web pages are rather “flat” and a conventional web server would place all of the information to be displayed through the web page into a formatted file that is delivered to a client for display by a conventional browser application. Here, server 310 is adapted and arranged to provide the various components of the information embedded into the response Y1 in a way that a respective tool can detect and show the source of the various components.

Specifically, when server 310 receives information to be placed into the response Y1, e.g., from servers 320, 330, or 340, each piece of information or component of the web page returned to client 300 is tagged or marked or annotated so as to retain the ability to deduce its source. The association of the information with the corresponding source of the information may be fixed in a source association tag for each such piece of information placed into a web page. For example, if server 340 returns pricing data to web server 310, the pricing data component of response Y1 is identified as having been derived from server 340. The present notion should be understood to extend to modular components of a server or machine in general, so for example if a single machine is acting as a pricing server, offer or CRM server, authentication server, and so on, these modules that contribute to the final response to client 300 are associated with their respective contributions in a way that can be determined if necessary or desired.

The above examples are useful in situations where troubleshooting is required to fix an error in the page generation process or in the data generation process for assembling a web page. In the present embodiments it becomes possible or easy to determine which server, machine, programmer, business unit, or software module was responsible for providing the erroneous data or contribution to the final web page. Once the source of the mistake or bug is located by examination of the contributor that contributed the erroneous data, the mistake, bug, or cause of the error can be addressed and corrected. This can be useful in situations where complicated systems are used to generate a final web page, such as occurs in generating modern online shopping web page results, where numerous programmers and parties are involved in generating portions of the final result given to a client.

In some embodiments, web server 310 includes software and/or hardware adapted and configured to examine the source association information or tag that associates a contributed piece of information with the machine or module that contributed it. In other embodiments, client 300 may be equipped with a type of browser application that detects tags or annotations in the web page Y1 so as to selectively show the source of the various components of information presented in the web page. In yet other embodiments, a quality control server or intermediate machine or client is introduced to pre-check the web pages produced by server 310 and to cause corrective action or warning signals if an error condition or anomaly is detected or suspected. The detection and evaluation of errors and anomalies may be done by a human user of a specially-equipped browser tool capable of monitoring and parsing the source association tags. In still other embodiments, an automated system comprising special hardware and software instructions executing on the hardware is used to monitor, parse, and take action responsive to information found in the association tags based on some pre-determined criterion for said action.

As disclosed above, the source association tags and tools for parsing these tags may be very useful in debugging and analyzing the contents of a web page that has multiple entities or machines or parties contributing to the contents of the web page. But also, in other embodiments, the source associations may be used to repair or correct errors in a compound web page by properly identifying the source of an error and causing it to be corrected.

Note that the present use of the term “tags” does not limit the concepts herein to any limited notion of tags in a conventional sense, but is intended to more broadly include data or information for tagging or identifying or associating or marking the components of the web pages and the sources of those components.

In some embodiments, a browser or browser-like application may be used to implement the above source association concepts. For example, one may build upon a web browser application further functionality and features so that the application is capable of special permissions or privileges for viewing the present source association tags. In one embodiment, a user of such an enhanced browser application would be allowed permission through a user interface to view the source association tags. Specifically, for example, a user of such an application may be allowed to move a pointer device over a web page returned to the user, on the user's computer screen, and the application would selectively display a message corresponding to content of the source association tag to which the user is pointing. The information may include all or some of the information in the source association tag, and may be presented as a pop-up box, dialog box, status message, color-coded message, or any other visual or audible message indicating to the user something about the contents of the source association tag. The display of such information may be automatically created for all such tags, or it may be selectively provided only when a user clicks on or hovers over or highlights a portion of a web page with an input device such as a computer mouse, pointer, or key entry apparatus.

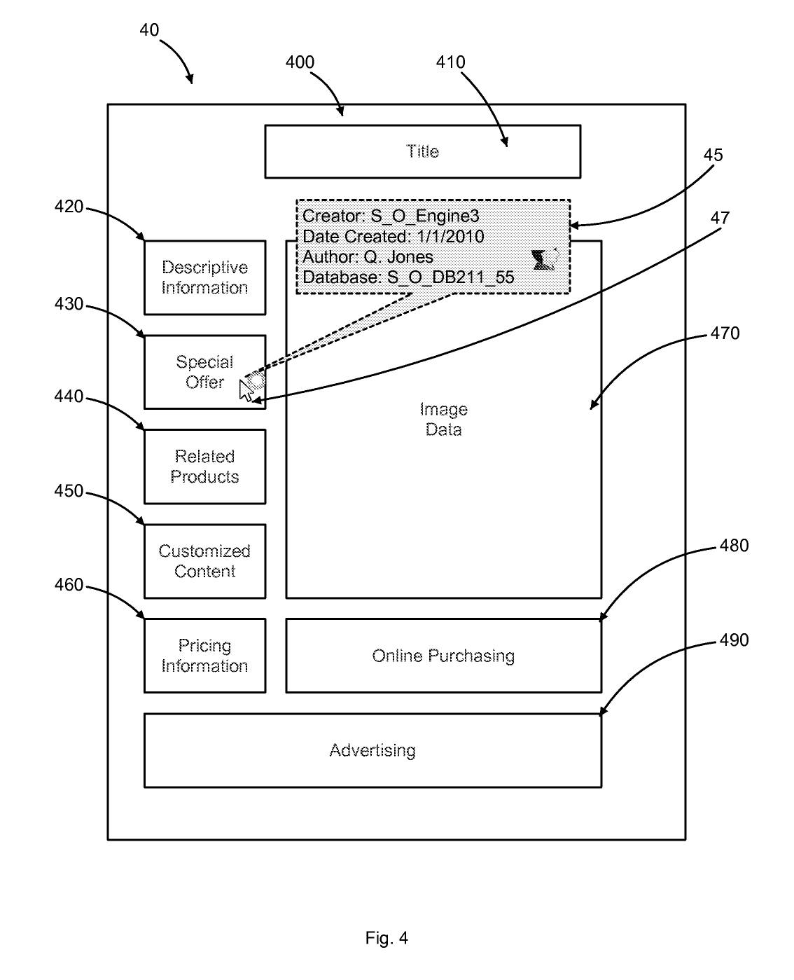

FIG. 4 illustrates a web page 40 in accordance to an embodiment, which has a plurality of components, various components therein having been generated from or provided by corresponding source servers, engines, or modules.

Page 40 includes some basic elements that describe the appearance and formatting of the page, e.g., the background 400 of the page. Page 40 also includes a Title 410 that generally describes the page. Also, one or more images or Image Data 470 is included in page 40, for example, pictures of a product that an online shopper is interested in. The Image Data 470 may be provided from an image source or database containing many such images. The page also includes other Descriptive Information 420 describing the product, which may come from a product description server or database. Further, any Special Offers 430 may be displayed to a user based on the identity of the user and the context in which the request for the page was made and other factors. The page may also show information about one or more Related Products 440, such as commonly used spare parts or refills or accessories. In addition, the page may provide Pricing Information 460, which may be computed by a pricing engine or sales unit. Also, an Online Purchasing section 480 may be provided so that the user can proceed to check-out or buy the selected merchandise. And in addition, Advertising content 490 may be displayed to the user in the web page 40, such advertising content possibly coming from a special advertising and marketing engine or other source of advertising text and graphics.

As disclosed above, a user (who may be a super-user or administrator or other privileged user) can, in some embodiments, select an element of web page 40 so as to reveal source association information about the element. For example, a user of an application as described herein may position a mouse or cursor 47 over a selected element, e.g., Special Offer element 430 of web page 40. This causes a display element 45 to pop up or appear or to be populated with information related to the source or contribution or authorship of the web page element 430. Here, a pop-up (balloon) appears on the user's screen, showing some or all information from the corresponding source association tag belonging to the Special Offer element 430 of the web page.

The display element 45 in the above example indicates that the Special Offer content was contributed by a server or module named “S_O_Engine3.” Also, it gives the Date Created as Jan. 1, 2010. In addition, if a programmer was responsible for the coding or data in Special Offer 430, the name of this Author (Q. Jones), and other contact information or a picture of the author is displayed like a phone book directory entry so that the responsible author for the web page element of interest can be contacted about the contribution he or she made. The database from which the Special Offer information was derived is also identified as “S_O_DB211_{—}55.”

As disclosed, embodiments in which the augmentation of web page content to include special identifying or source-association data can have useful applications in web page processing and construction. Among other features, various embodiments hereof allow easier tracking of authorship and source of data in complex multi-element web pages, which will allow easier debugging and correction to faulty code or servers contributing to the web page.

In some aspects and embodiments, a “preview server” is employed to preview how a page may appear to a user viewing the page with the present active browser. Various, or all, versions of a page may be reviewed by authors, editors, or supervisory personnel in preparation of a page or web site for use herewith. So, for example, if a “holiday version” of a page or site is under construction, this can be captured and retained and reviewed using appropriate versioning tools. The tools described here allow, in some aspects, for authors and editors of web pages and related content to experience the pages exactly as an end user would experience them or see the same.

In some aspects and embodiments, each (or a group of) item(s) on the screen are associated with an ID tag. The server may push the ID tag for the required items to the browser. Then, interaction with the items by the user would cause pulling of the data relating to that item from an appropriate repository of such information.

In some aspects and embodiments, a user interface is provided with or associated with the pop-up window indicators viewable with the above active browser application. For example, a user can interact using the user interface (UI) with elements within the pop-up window such as using a computer mouse, touch screen pad, stylus input device, voice interactivity, and so on. The interface may be writable, allowing information to be written, drawn, or typed into an appropriate space or input element in the user interface.

Several embodiments are specifically illustrated and/or described herein. However, it will be appreciated that modifications and variations of the disclosed embodiments are covered by the above teachings and within the purview of the appended claims without departing from the spirit and intended scope of the invention.

What is claimed is:

1. A computer readable medium having instructions stored thereon that, when executed by a processor, causes the processor to process a web page request, the instructions comprising:
receiving the web page request from a client;
determining a plurality of data elements required for servicing the web page request;
generating a web page responsive to the web page request, wherein the generating comprises generating a plurality of elements of the web page, each element including a respective data element from a respective source, and including a respective source association tag identifying at least the respective source of each of the respective data elements; and
transmitting the web page including the plurality of web page elements and respective source association tags to the client.

2. The computer readable medium of claim 1, wherein the respective source includes a second server.

3. The computer readable medium of claim 1, wherein the respective source includes a database.

4. The computer readable medium of claim 2, wherein the source association tag comprises an identity of the second server.

5. The computer readable medium of claim 3, wherein the source association tag comprises an identity of the database.

6. The computer readable medium of claim 1, wherein the source association tag comprises an identity of a creator of the data element and contact information of the creator.

7. The computer readable medium of claim 1, wherein the source association tag comprises a date of creation of the data element.

8. The computer readable medium of claim 1, wherein the source association tag causes a display element to be generated at the client for a data element, wherein the display element displays source association tag information.

9. A computer-implemented method for responding to a request for a web page from a client, the method comprising:
determining a plurality of data elements required to generate the web page;
requesting and receiving the plurality of data elements, wherein each data element is requested and received from a respective source;
for each respective source, generating a source association tag that identifies the source and the corresponding data element;
generating the web page comprising the plurality of data elements and corresponding source association tags; and
transmitting the web page to the client.

10. The method of claim 9, wherein the respective source includes a second server.

11. The method of claim 9, wherein the respective source includes a database.

12. The method of claim 10, wherein the source association tag comprises an identity of the second server.

13. The method of claim 11, wherein the source association tag comprises an identity of the database.

14. The method of claim 9, wherein the source association tag comprises an identity of a creator of the data element and contact information of the creator.

15. The method of claim 9, wherein the source association tag comprises a date of creation of the data element.

16. The method of claim 9, wherein the source association tag causes a display element to be generated at the client for a data element, wherein the display element displays source association tag information.

17. A system for responding to a request for a web page from a client, the method comprising:
a data element requestor that requests and receives a plurality of data elements required by the web page, wherein each data element is requested and received from a respective source;
a tag generator that generates a source association tag for each data element, wherein each tag identifies the respective source of the data element; and
a web page server that generates the web page comprising the plurality of data elements and corresponding source association tags and transmits the web page to the client.

18. The system of claim 17, wherein the source association tag comprises an identity of a creator of the data element and contact information of the creator.

19. The system of claim 17, wherein the source association tag comprises a date of creation of the data element.

20. The system of claim 17, wherein the source association tag causes a display element to be generated at the client for a data element, wherein the display element displays source association tag information.
